(19) United States
(12) Patent Application Publication
(10) Pub. No.: US 2026/0146947 A1
(43) Pub. Date: May 28, 2026

(54) Methods And Systems For Dynamic Range Enhancement Of Fluorescence Detectors

(71) Applicants: THERMO FISHER ELECTRON SCIENTIFIC INSTRUMENTS LLC (a Delaware corporation), Madison, WI (US); LIFE TECHNOLOGIES CORPORATION (a Delaware corporation), Carlsbad, CA (US)

(72) Inventors: Julian James Irwin, Madison, WI (US); Wesley Glen Smith, Elmira, OR (US)

(21) Appl. No.: 18/956,167

(22) Filed: Nov. 22, 2024

(51) Int. Cl. G01N 21/64

(52) U.S. Cl. CPC G01N 21/6408; G01N 21/6458; G01N 2021/6413; G01N 2021/6434; G01N 2201/123

(57) ABSTRACT

Methods and apparatuses dynamic range enhancement of fluorescence detectors are described herein. In one aspect, a method can include collecting, from a sample during a sample event, an emission spectrum that comprises a plurality of emission signals; based on reception times associated with emission signals of the plurality of emission signals, determining a lifetime estimation for the sample; determining, based at least on the lifetime estimation, a pileup factor affecting receiving emissions from the sample; and based on the determined pileup factor, adjusting a number of emission signals measured during the sample event to generate an estimated number of emissions for the sample event.

### TECHNICAL FIELD

The present invention relates generally to emission signal detection of samples in sample examination systems.

### BACKGROUND

Time resolved photon counting arrays are desired for full spectrum flow cytometry due to their low noise and high speed. One challenge associated with using photon counting arrays is achieving a useful dynamic range, as the second of two nearly temporally coincident photons may be undetected and thus effectively lost, a phenomenon called pileup.

One example of a photon counting array is a single photon avalanche diode (SPAD) array. Each pixel in the SPAD array can only count a certain number of photons within a given time frame. This is due to both the time-to-digital (TDC) converter electronics and the actual SPAD dead time (e.g., the pixel requires a recharge after each avalanche).

### SUMMARY

Methods and systems for accurate emission signal detection of samples in sample examination systems are described herein. In one aspect, a method can include collecting, from a sample during a sample event, an emission spectrum that comprises a plurality of emission signals; based on reception times associated with emission signals of the plurality of emission signals, determining a lifetime estimation for the sample; determining, based at least on the lifetime estimation, a pileup factor affecting receiving emissions from the sample; and based on the determined pileup factor, adjusting a number of emission signals measured during the sample event to generate an estimated number of emissions for the sample event.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 depicts a sample examination system according to the present disclosure.

FIG. 2 depicts emission signals for collection by a detector according to the present disclosure.

FIG. 3 depicts a graphical representation of measured photon counts and true photon counts for a sample, according to the present disclosure.

FIG. 4 depicts optical pathways for emission signal collection according to the present disclosure.

FIG. 5 depicts a detector array according to the present disclosure.

FIG. 6 depicts a process flow for examining samples according to the present disclosure.

FIG. 7 depicts a controller for sample examination systems according to the present disclosure.

FIG. 8 depicts a graphical representation of estimated lifetime versus mean photons per exposure. Higher mean photons represents a brighter fluorescence signal. Brighter signals have a high chance of multiple photons hitting the detector after one laser pulse, and all photons after the first being lost, thus skewing the lifetime to a lower estimate value. The violin histograms at each point show the spread of estimates after 30 repeated measurements.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps can be performed in any order. Any documents cited herein are incorporated by reference in their entireties for any and all purposes.

It is to be appreciated that certain features of the invention which are, for clarity, described herein in the context of separate embodiments, can also be provided in combination in a single embodiment. Conversely, various features of the invention that are, for brevity, described in the context of a single embodiment, can also be provided separately or in any subcombination. Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

Methods and systems for accurate emission signal detection of samples in sample examination systems are described herein. Photon count detectors, such as SPAD detectors, can be incapable of detecting some of the emissions received from a sample. For example, SPAD detectors can include reset times, where a pixel of the SPAD detector is unavailable to detect photons after detection of a prior photon. Thus, in cases, where an emission signal is received at a SPAD pixel within the pixel's reset time, the emission signal is not counted or lost, which can provide for inaccurate emission count for the sample.

The present disclosure provides systems and methods for addressing these problems. Emission signals from a sample can be received at a detector array, such as one or more SPAD detectors. The emission signals can be temporally dispersed, and the particular detector arrival times for a respective emission signal can be monitored, which can be referred to as the measured lifetime of the sample or fluorescence of the sample. The arrival times can be fitted to a model function, such as a function including a regression method. The function can output a lifetime estimation for the sample or fluorescence, which can be referred to as the actual lifetime for the sample or fluorescence. A difference or ratio between the actual lifetime and the estimated lifetime can be determined, which can form the basis for adjusting an emission signal count measured by the detector. The methods described herein can thus facilitate a more accurate emission signal count for sample examination systems.

Fluorescence emission can include negative exponential time dependence, where the decay constant is referred to as fluorescence lifetime. Time resolved detection of fluorescence emission excited by a pulsed laser can result in a negative exponential curve that can be fitted to extract a lifetime estimate. Thus, slight shifts in the estimated lifetime can be utilized to infer signal brightness, thus extending dynamic range. Brighter signals can be more likely to hit the detector with a photon earlier in time, thus recording an early time event and disabling the detector for any photons that strike at later times. This results in a skewing of the lifetime towards earlier times. The same fluorophore with the same physical lifetime can be measured to have a shorter lifetime if the signal is sufficiently bright. This can therefore be exploited to extend the sensor dynamic range, solving the problem of detector pileup.

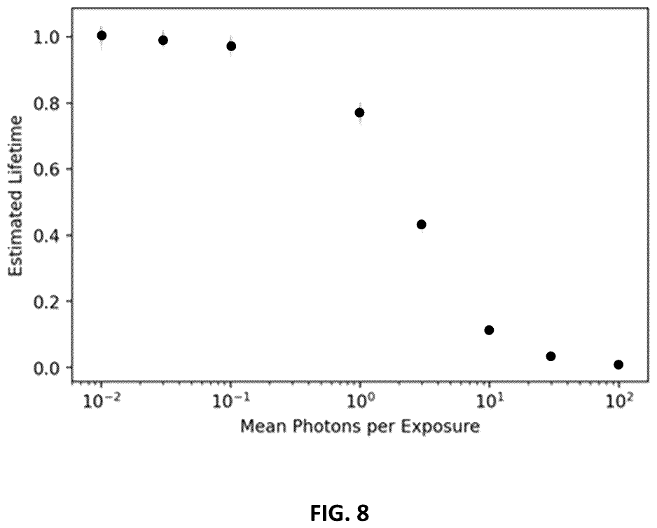

To demonstrate this, consider a detector repeatedly exposed for some constant exposure time to fluorescence excited by a laser pulse. The number of photons that hit the detector after each pulse can be Poissonian with some rate constant. The arrival time of the photons can be negative exponential, assuming the laser pulse width is much shorter than the fluorescence lifetime. For each laser pulse, the time of only the earliest photon to hit the detector can be recorded, which can simulate the detector/TDC dead time. This can be repeated until N events have been recorded, and the arrival times can be fit to an exponential distribution to estimate the lifetime. FIG. 8 shows that as the Poisson rate constant (brightness of fluorescence emission) is increased, the estimated lifetime can decrease. The lifetime can be normalized. The calculation highlights that for mean rates below 0.1 photons/exposure the estimated lifetime can be accurate—close to one. However, the estimated lifetime can drop to 10% of its true value when the rate constant reaches 10 photons/exposure. The slope of the estimated lifetime versus brightness curve can decrease significantly beyond 10 photons/exposure reducing the sensitivity of lifetime to brightness. This suggests that about two orders of magnitude of extra dynamic range can be achieved through lifetime estimation, from 0.1 photons/second to 10 photons/second.

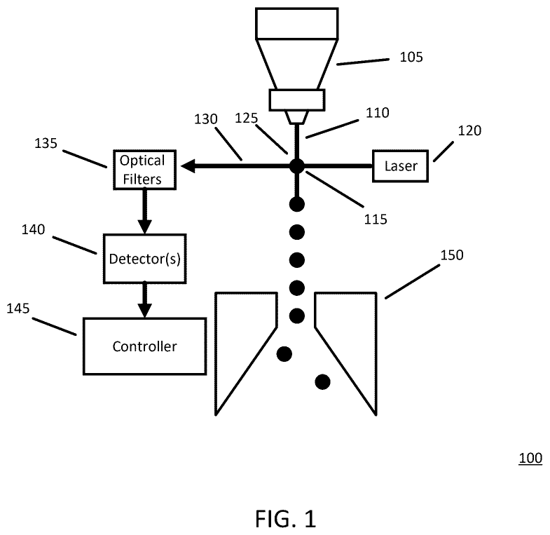

FIG. 1 depicts system 100 according to the present disclosure System 100 may include a flow cytometer. It should be understood that the disclosed technology is not limited to flow cytometers or to flow cytometry applications. A sample can be sent through a nozzle 105 under pressurized conditions and can create a stream 110 at the output of the nozzle 105. The stream 110 breaks off into a series of samples 115. Laser 120 can irradiate samples (e.g., cells) within the sample at interrogation site 115. Depending upon the type of sample that is irradiated by the laser 120, the sample can generate an optical response. The optical response can be forward scattered light or forward fluorescent emissions 130. Alternatively, or in addition, the response of the sample to the irradiation by laser 120 can be side-scattered light, or side fluorescent emissions. These responses are transmitted through optical filters 135 to detector 140.

The detector 140 can generate output signals that have a magnitude that is indicative of the intensity of the light collected from the cell, at the specific frequencies of the optical filters 135. In some cases, the controller 145 can generate an event data signal based on the output signals received from the detector 140. For example, the event data signal can include a time stamp to identify the data with a particular cell. In some cases, the event data signal can include sorting information. For example, the controller 145 can implement sorting logic to perform sort decisions that are based upon the biological response of the particular types of cells that are being sorted. Statistical calculations of the likelihood of an event belonging to a certain population can be used for making the sort decision. The event data signal can be used to control deflector plates 150 to charge a droplet prior to breaking off from the stream 110 (e.g., for sorting purposes). In some cases, the output signals from the detector 140 can include a photocount value.

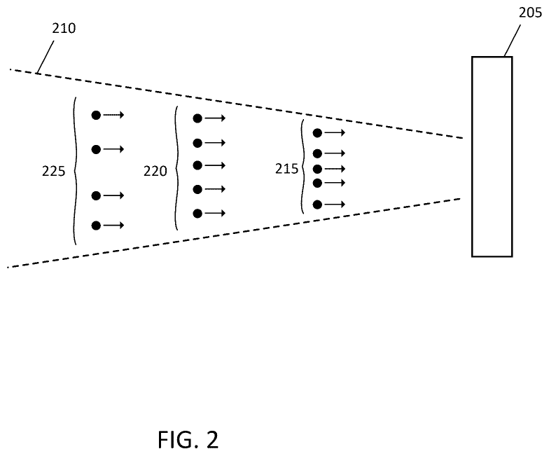

FIG. 2 depicts a detector 205 according to the present disclosure. The detector 205 can in be an example of the detector 140 as described with reference to FIG. 1. The detector 205 can be a time resolved, photon counting detector array. In some cases, the detector 205 can be a SPAD array.

The detector 205 can be a part of a sample examination system, such as flow cytometry system 100 of FIG. 1. A sample of the sample examination system can receive an excitation light signal, and emit emissions 210. The emissions can be directed towards the detector 205. The emissions 210 can be distributed across space and time. For example, with respect to spatial distribution, the emissions 210 can be spaced apart such that different emissions are received by different portions such as pixels of the detector 205. With respect to temporal distribution, the emissions 210 can be received across a sampling event, which can correspond to a time window beginning with the sample receiving the light signal, and extending for a period of time. Thus, the detector 205 can receive emission signals 215 at a first time, emission signal 220 at a second time, and emission signals 225 at a third time, for example. However, each of the emission signals, 215, 220, and 225 can be a part of the emissions 210, and can be received within the sampling event (e.g., the light pulse interacting with the sample can generate the emissions 215, 220, and 225).

There can be cases where the detector 205 cannot detect one or more of the emissions received from the sample. For example, in the cases where the detector 205 includes a SPAD array, a pixel within a pixel reset time can be unable to detect another emission signal when the emission signal arrives at the pixel. In the example of FIG. 2, a pixel of the detector 205 can receive and detect an emission signal 215 at a first time. The pixel can then receive an emission signal 220 a second time subsequent to the first time. If the second time falls within the pixel's reset time, the emission signal 220 can fail to be detected at the pixel. This phenomenon is known as pileup. Pileup can cause the detector 205 to inaccurately detect the emission signals 210 during the sampling event, which can skew total photon counts for the sample, and other analyses associated with sample examination (e.g., identifying or characterizing the sample, and the like).

According to the present disclosure, a sample examination system can mitigate the inaccuracies surrounding pileup by estimating the true lifetime of the examined sample. Estimating the true lifetime can include fitting measured emission signal counts from an examined sample to a best fit function. By identifying a difference between the true lifetime of the examined sample with the measured lifetime of the examined sample, a difference or ratio can be determined, which can be implemented for modifying the emission signal count of the detector, characterizing the examined sample, and the like.

The processes described below can be implemented by a sample examination system, such as system 100 described with reference to FIG. 1. The detector 140 can receive a plurality of emission signals 130 generated by a sample, such as sample 115. The emission signals can correspond to a sampling event of the sample 115, where the sample 115 receives examination signals, such as a laser beam pulse. The sampling event can, for example, initiate at the time the sample 115 receives the examination signal (e.g., originating from laser 120). In some cases, the sampling event can initiate at the time the examination signal source (e.g., laser 120) generates the examination signal.

During the sampling event, the emissions 130 can be received by the detector 140 (e.g., via an optical pathway including the filters 135). The emissions 130 can be spatially distributed, such that different spectral channels receive different portions of the emissions 130. For example, in the case of the detector 140 including a SPAD detector or array, the one or more SPAD pixels can be a spectral channel.

Once a spectral channel of the detector 140 receives an emission signal the detector can register or measure the emission signal. For example, for the SPAD example, a SPAD pixel can receive an emission signal such as a photon, and record the signal. The detector 140, or associated circuitry such as controller 145 can record the signal, as a count, along with a time associated with the detector's measuring of the signal (e.g., as a timestamp).

During the sampling event, the detector 140 can continue to receive and measure emission signals of the emissions 130, along with monitoring the times in which the emission measurements are taken.

After expiration of the sample event (or at another predefined time), the system 100 (e.g., the controller 145, or a computing device not shown) can extract the measured fluorescence lifetime of the sample 115 from the recorded data. For example, the measured fluorescence lifetime of the sample 115 can be determined by fitting the recorded data (e.g., the emissions signal count and associated times) to a model function. The model function can include a regression method such as least squares. For example, the model function can determine a line-of-best-fit for the signal count and time data. In some cases, the line-of-best-fit can take the form of an equation, such as (1/τ)*exp(−t/τ), where t can be a time for reception of an emission signal, and τ can be a lifetime for the sample.

The system 100 can also identify or determine a known or actual lifetime for the sample 115. In some cases, the known lifetime for the sample 115 can be stored (e.g., either by the system 100 or by external storage (not shown)). For example, the actual lifetime can be stored as a numerical value, such as a time value corresponding to how long it takes for the sample to decay to a defined population percentage while in an excited state. In some cases, the actual lifetime can be stored as data points of emission counts as a function of time, similar to how the measured or estimated lifetime is measured. In some cases, the actual lifetime can be identified based on a name or characteristic of the sample 115. For example, if the sample 115 includes a known fluorophore type, the actual lifetime can be stored with an identifier associated with the fluorophore type.

Alternatively, the actual lifetime can be measured during a calibration process. For example, the system 100 can perform a calibration examination on a sample, which can implement optical components to mitigate the possibility of pileup. In some cases, the sample used for calibration can include known characteristics, or for example, can be the composition of the sample 115. In some cases, the system 100 can implement optical filters to reduce the intensity of emissions signals received by a detector, which can provide a more accurate lifetime estimation.

The system 100 can determine differences between the actual lifetime and the measured lifetime for the sample 115. By reference to the non-limiting example of a fluorophore, such differences can be indicative of the type of fluorophore. Differences can also be indicative of a state of the fluorophore, e.g., that the fluorophore is disposed in an environment of a particular pH or of a particular pH range. In some cases, the actual lifetime can be compared to the measured lifetime. For example, in some cases a numerical value of the actual lifetime and a numerical value of the measured lifetime can be compared (e.g., t). In some cases, the functions representing the actual lifetime and the measured lifetime can be compared.

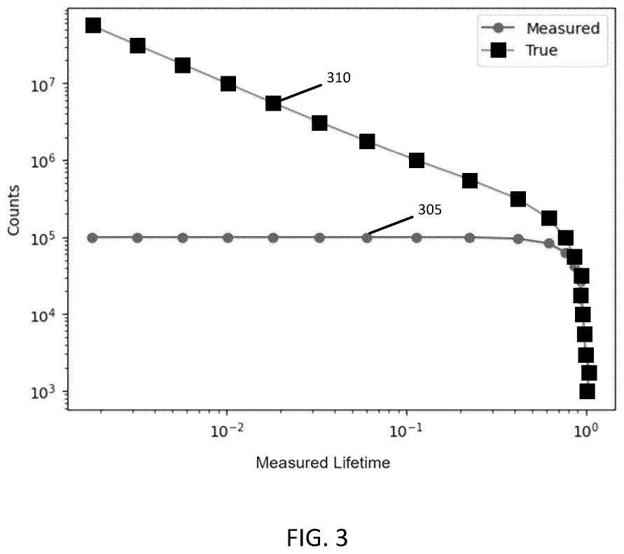

In some cases, the difference between the actual lifetime and the measured lifetime can be represented as a pileup loss fraction. For example, the pileup loss fraction can be represented as a numerical value between 0 and 1. The pileup loss fraction can represent a number of emission signals that were failed to be detected by the detector during the sampling event. In some cases, the pileup loss fraction can be output from a model function, where the input to the model function can be the measured lifetime and the actual lifetime for the sample 115. FIG. 3 depicts a graphical representation of pileup loss. In this depiction measure lifetime is normalized, meaning measured lifetime of one is the true lifetime of the sample. As depicted, the measured photon counts 305 and true photon counts 310 can be equal or nearly equal for measured lifetimes near one. For measured lifetimes less than one, the true photon counts 310 can be larger than the measured photon counts 305, the difference coming from the pileup loss fraction. By identifying the difference between the measured lifetime and true lifetime, or which x-axis coordinate in FIG. 3 a particular sample is located, the system can estimate the pileup loss fraction and account for pileup losses.

In some cases, an emissions count for the sample 115 can be adjusted based on the pileup loss fraction. For example, the detector 140 can detect a total number of emission signals detected by the detector for a sample event. For example, a total signal count can be aggregated for the sample event across spectral channels. Based on the pileup loss fraction, the total signal count can be adjusted. This adjustment or modification can thus take into account pileup loss experienced by the detector 140, and provide a more accurate value of the measured lifetime of the sample (e.g., from counts 305 to counts 310 of FIG. 3). In some cases, the adjustment of the signal count can take the form of: TPC=MPC/(1−PLF); where TPC can be a number of true number of emissions emitted by the sample; MPC can be the plurality of emissions signals received by the detector during the sample event time, and PLF can be the pileup factor.

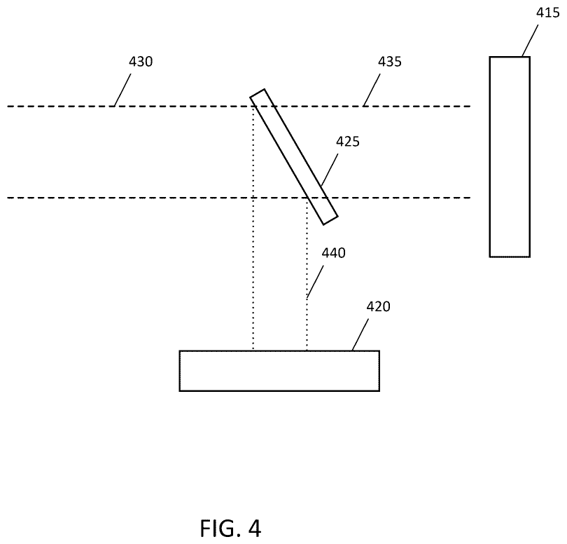

FIG. 4 depicts a configuration for detectors of a sample examination system according to the present disclosure. The detectors can be a part of, in some cases, system 100 of FIG. 1 (e.g., detectors 140). The configuration can include a first detector 415 and a second detector 420. In some cases, the first detector 415, the second detector 420, or both, can include a SPAD array or detector. One or more optical components 425 can be positioned between the detectors 415, 420 and the sample of the system (e.g., sample 115 of FIG. 1). In some cases, the optical components can include a beam splitter, such as a 90/10 beam splitter, an 80/20 beam splitter, and the like. The optical components 425 can receive emission signals 430 (e.g., emission signals 130 of FIG. 1) emanated from a sample during a sampling event, and can redirect a portion of the emission signals. A first emission signal portion 435 can be directed to the first detector 415, and a second emission signal portion 440 can be directed to the second detector 420. In the case where the optical components 425 include a beam splitter, the first emission signal portion 435 and the second emission signal portion 440 can include intensities based on the type of beam splitter. For example, in the case of a 90/10 beam splitter, the first emission signal portion 435 can include an intensity that is 90 percent of the intensity of the emission signals 430, and the second emission signal portion 440 can include an intensity of 10 percent of the intensity of the emission signals 430.

The first detector 415 and the second detector 420 can act as bright and dim channels for the examination system. For example, in the case where the first detector 415 receives a high portion of the emission signals 430, the first detector 415 can experience pileup earlier in time as opposed to the second detector 420. In some cases, each of the first detector 415 and the second detector 420 can monitor reception times of emission signals received, as discussed in more detail above. Measured lifetimes can be determined for each of the emission signal counts detected at the first detector 415 and the second detector 420. In cases where pileup is experienced at the first detector 415, the lifetime best fit function for the signal count of the first detector 415 will vary compared to the lifetime best fit function for the signal count of the second detector 420 (due to pileup). Thus, in some cases, the measured lifetime for the sample by the second detector 420 can act as the true or actual lifetime for the sample, and can replace the calibration processes described above for determining the actual lifetime of the sample.

In some cases, the second detector 420 can act as a secondary detector for the system. For example, the second detector 420 can refrain from detecting emission signals until instructed to do so, whereas the first detector 415 can detect emission signals. The signal count detected by the first detector 415 can be implemented for measured lifetime determinations, and can be compared to an actual lifetime of the sample. If the differences between the measured lifetime and the actual lifetime are above a predefined threshold, the system can switch to measuring emissions via the second detector (e.g., due to the system determining the first detector 415 is experiencing sufficient pileup).

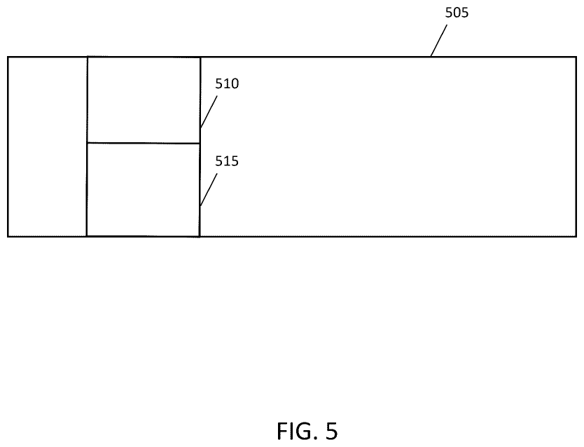

In some cases, the dim and bright channels can be of a single detector array. For example, FIG. 5 depicts a detector 505, which can be an example of detector 140 of FIG. 1. The detector 505 can be a SPAD detector or array. The detector 505 can include a bright channel 510 and a dim channel 515, where the bright channel 510 can be composed of one or more spectral channels (e.g., pixels), and the dim channel 515 can be composed of one or more spectral channels different from the bright channel 510. The bright channel 510 can be implemented similar to the first detector 415 of FIG. 4. Likewise, the dim channel 515 can be implemented similar to the second detector 420 of FIG. 4. For example, the emission signals resulting from sample examination can travel through optical components, which can diverge portions of the emissions signals toward the bright channel 510 and the dim channel 515.

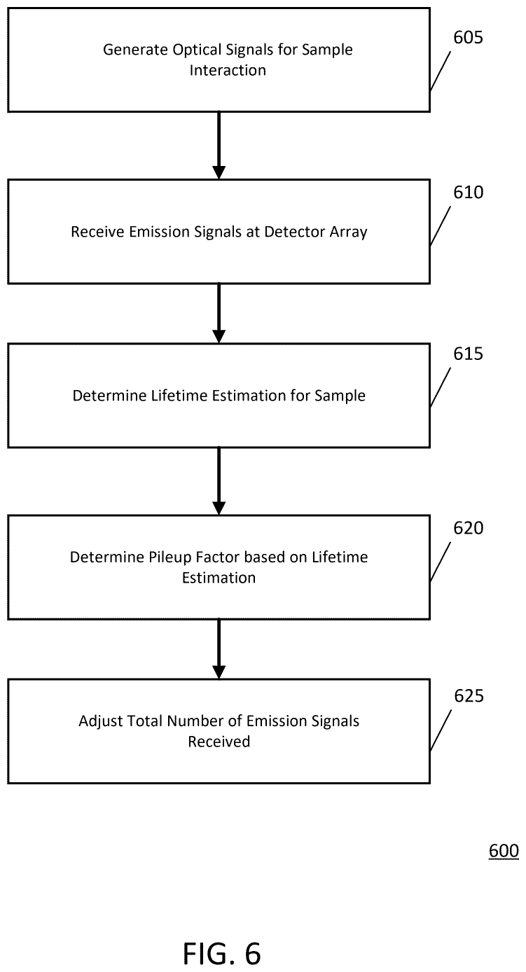

FIG. 6 depicts a process 600 for sample examination according to the present disclosure. The process 600 can be implemented by, for example, system 100 as described with reference to FIG. 1.

At Step 605, one or more optical signals can be configured to interact with a sample disposed in an examination system. In some cases, the one or more optical signals can include one or more laser pulses configured to excite the sample during the interacting. In some cases, the one or optical signals can interact with the sample at an interrogation or examination site of the system. In some cases, the interaction can initiate a sample event time corresponding to the sample.

At Step 610, a detector array can receive, during the sample event time, a plurality of emission signals emitted from the sample based on the sample interacting with the one or more optical signals. In some cases, the sample can include, or be, a fluorophore. The emission signals can include fluorescence emitted from the sample. In some cases, the emissions signals can travel through an optical pathway of the sample examination system, which can include one or more optical components. In some cases, the optical components can direct, filter, condition, or a combination thereof, the emission signals received at the detector array. In some cases, the detector array can include a SPAD detector or array, which can include a plurality of pixels configured to receive and detect photon emissions from the sample.

At Step 615, a lifetime estimation for the sample can be determined based on reception times associated with at least some of the plurality of emission signals received by the detector array during the sample event. The system can record an emission signal, along with an associated reception time for the emission signal at the detector. In some cases, the emission signal and reception time data can be input into a model function, which can include a best regression function, for example a least squares function. In some cases, the model can output a best lifetime estimation for the sample. In some cases, some of the plurality of emission signals can remain undetected by the detector array, for example due to the detector array experiencing pileup.

At Step 620, a pileup factor affecting the detector receiving emissions from the sample can be determined. In some cases, the pileup factor can be determined based on the lifetime estimation. In some cases, the pileup factor can be determined based on an actual lifetime for the sample. For example, the actual lifetime for the sample can be stored by the examination system or other storage, or can be determined via a calibration process by the sample examination system. In some cases, the pileup factor can be determined by determining a deviation between the estimated lifetime and the actual lifetime.

At Step 625, a total number of emission signals received at the detector during the sample event can be adjusted. In some cases, the adjusting can be based on the lifetime estimation of the sample, the actual lifetime of the sample, the pileup factor, the deviation between the lifetime estimation of the sample and the actual lifetime of the sample, of a combination thereof.

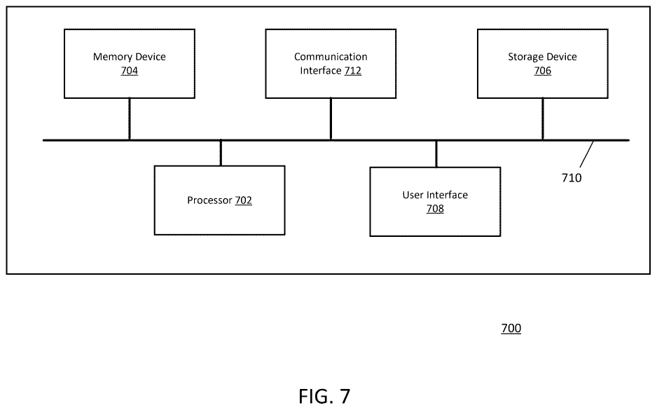

FIG. 7 depicts a controller 700 according to the present disclosure. The controller 700 can be an example of controller 145 discussed with reference to FIG. 1

The controller 700 can be a computing device such as a microcontroller, general purpose computer (e.g., a personal computer or PC), workstation, mainframe computer system, and so forth. The controller 700 can include a processor device (e.g., a central processing unit or “CPU”) 702, a memory device 704, a storage device 706, a user interface 708, a system bus 710, and a communication interface 712.

The processor 702 can be any type of processing device for carrying out instructions, processing data, and so forth.

The memory device 704 can be any type of memory device including any one or more of random access memory (“RAM”), read-only memory (“ROM”), Flash memory, Electrically Erasable Programmable Read Only Memory (“EEPROM”), and so forth.

The storage device 706 can be any data storage device for reading/writing from/to any removable and/or integrated optical, magnetic, and/or optical-magneto storage medium, and the like (e.g., a hard disk, a compact disc-read-only memory “CD-ROM”, CD-ReWritable CDRW,” Digital Versatile Disc-ROM “DVD-ROM”, DVD-RW, and so forth). The storage device 706 can also include a controller/interface for connecting to the system bus 710. Thus, the memory device 704 and the storage device 706 are suitable for storing data as well as instructions for programmed processes for execution on the processor 702.

The user interface 708 can include a touch screen, control panel, keyboard, keypad, display or any other type of interface, which can be connected to the system bus 710 through a corresponding input/output device interface/adapter.

The communication interface 712 can be adapted and configured to communicate with any type of external device, or with other components of the sample examination system. For example, arrowed lines, such as those illustrated in FIG. 1, can illustrate electronic communication between the controller (e.g., controller 145 of FIG. 1) and another component of the sample examination system (e.g., the detector 140). The communication interface 712 can further be adapted and configured to communicate with any system or network, such as one or more computing devices on a local area network (“LAN”), wide area network (“WAN”), the Internet, and so forth. The communication interface 712 can be connected directly to the system bus 710 or can be connected through a suitable interface.

The controller 700 can, thus, provide for executing processes, by itself and/or in cooperation with one or more additional devices, that can include algorithms for controlling components of the sample examination system in accordance with the present disclosure. The controller 700 can be programmed or instructed to perform these processes according to any communication protocol and/or programming language on any platform. Thus, the processes can be embodied in data as well as instructions stored in the memory device 704 and/or storage device 706, or received at the user interface 708 and/or communication interface 712 for execution on the processor 702.

### EXEMPLARY EMBODIMENTS

The following embodiments are exemplary only and do not serve to limit the scope of the present disclosure of the appended claims. It should be understood that any part of any one or more Embodiments can be combined with any part of any other one or more Embodiments.

### Embodiment 1

A method, comprising: collecting, from a sample during a sample event, an emission spectrum that comprises a plurality of emission signals; based on reception times associated with emission signals of the plurality of emission signals, determining a lifetime estimation for the sample; determining, based at least on the lifetime estimation, a pileup factor affecting receiving emissions from the sample; and based on the determined pileup factor, adjusting a number of emission signals measured during the sample event to generate an estimated number of emissions for the sample event.

### Embodiment 2

The method of Embodiment 1, wherein determining the lifetime estimation for the sample comprises: fitting the reception times for each of the plurality of emissions signals to a model function.

### Embodiment 3

The method of any of Embodiments 1 through 2, further comprising: determining an actual lifetime for the sample, wherein the pileup factor is further based on the actual lifetime for the sample.

### Embodiment 4

The method of any of Embodiments 1 through 3, wherein determining the actual lifetime comprises: retrieving the actual lifetime from electronic storage.

### Embodiment 5

The method of any of Embodiments 1 through 4, wherein determining the actual lifetime comprises: measuring the actual lifetime from a second detector configured to measure the actual lifetime of the sample during the sample event.

### Embodiment 6

The method of any of Embodiments 1 through 5, wherein the second detector is configured to receive a second plurality of emission signals from the sample during the sample event, and wherein a count of the second plurality of emissions is less than a count of the plurality of emissions.

### Embodiment 7

The method of any of Embodiments 1 through 6, wherein the detector comprises a bright channel, and wherein the second detector comprises a dim channel.

### Embodiment 8

The method of any of Embodiments 1 through 7, wherein determining the pileup factor comprises: determining a deviation between the estimated lifetime and the actual lifetime; and calculating the pileup factor based on the deviation.

### Embodiment 9

The method of any of Embodiments 1 through 8, wherein the adjusting is according to:

$$TPC = MPC / ( 1 - PLF ) ;$$

wherein TPC comprises a number of true number of emissions emitted by the sample; MPC comprises the plurality of emissions signals received by the detector during the sample event time, and PLF comprises the pileup factor.

### Embodiment 10

The method of any of Embodiments 1 through 9, wherein the sample examination system comprises a flow cytometry system.

### Embodiment 11

The method of any of Embodiments 1 through 10, further comprising classifying the sample based at least in part on the pileup factor.

### Embodiment 12

An apparatus, comprising: a processor, and computer-executable instructions that, when executed by the processor, cause the apparatus to: collect, during a sample event and by a detector of a sample examination system, an emission spectrum of a sample, wherein the emission spectrum comprises a plurality of emission signals from the sample; determine a lifetime estimation for the sample based on reception times associated with at least some of the plurality of emission signals received by the detector during the sample event; determine, based at least on the lifetime estimation, a pileup factor affecting the detector receiving emissions from the sample; and adjust a total number of emission signals received at the detector during the sample event based on the determined pileup factor.

### Embodiment 13

The apparatus of Embodiment 12, wherein determining the lifetime estimation for the sample comprises: fitting the reception times for each of the plurality of emissions signals to a model function.

### Embodiment 14

The apparatus of any of Embodiments 12 through 13, wherein the computer-executable instructions, when executed, further cause the apparatus to: determine an actual lifetime for the sample, wherein the pileup factor is further based on the actual lifetime for the sample.

### Embodiment 15

The apparatus of any of Embodiments 12 through 14, wherein determining the actual lifetime comprises: retrieving the actual lifetime from electronic storage.

### Embodiment 16

The apparatus of any of Embodiments 12 through 15, wherein determining the actual lifetime comprises: measuring the actual lifetime from a second detector configured to measure the actual lifetime of the sample during the sample event.

### Embodiment 17

The apparatus of any of Embodiments 12 through 16, wherein the second detector is configured to receive a second plurality of emission signals from the sample during the sample event, and wherein a count of the second plurality of emissions is less than a count of the plurality of emissions.

### Embodiment 18

The apparatus of any of Embodiments 12 through 17, wherein the detector comprises a bright channel, and wherein the second detector comprises a dim channel.

### Embodiment 19

The apparatus of any of Embodiments 12 through 18, wherein determining the pileup factor comprises: determining a deviation between the estimated lifetime and the actual lifetime; and calculating the pileup factor based on the deviation.

### Embodiment 20

The apparatus of any of Embodiments 12 through 219, wherein the adjusting is according to:

$$TPC = MPC / ( 1 - PLF ) ;$$

wherein TPC comprises a number of true number of emissions emitted by the sample; MPC comprises the plurality of emissions signals received by the detector during the sample event time, and PLF comprises the pileup factor.

### Embodiment 21

The apparatus of any of Embodiments 12 through 20, wherein the sample examination system comprises a flow cytometry system.

### Embodiment 22

The apparatus of any of Embodiments 12 through 21, wherein the computer-executable instructions, when executed, further cause the apparatus to: classify the sample based at least in part on the pileup factor.

### Embodiment 23

A non-transitory, computer-readable medium comprising computer-executable instructions that, when executed, cause: collecting, from a sample during a sample event, an emission spectrum that comprises a plurality of emission signals; based on reception times associated with emission signals of the plurality of emission signals, determining a lifetime estimation for the sample; determining, based at least on the lifetime estimation, a pileup factor affecting receiving emissions from the sample; and based on the determined pileup factor, adjusting a number of emission signals measured during the sample event to generate an estimated number of emissions for the sample event.

### Embodiment 24

The non-transitory, computer-readable medium of Embodiment 23, wherein determining the lifetime estimation for the sample comprises: fitting the reception times for each of the plurality of emissions signals to a model function.

### Embodiment 25

The non-transitory, computer-readable medium of any of Embodiments 23 through 24, wherein the computer-executable instructions that, when executed, further cause: determining an actual lifetime for the sample, wherein the pileup factor is further based on the actual lifetime for the sample.

### Embodiment 26

The non-transitory, computer-readable medium of any of Embodiments 23 through 25, wherein determining the actual lifetime comprises: retrieving the actual lifetime from electronic storage.

### Embodiment 27

The non-transitory, computer-readable medium of any of Embodiments 23 through 26, wherein determining the actual lifetime comprises: measuring the actual lifetime from a second detector configured to measure the actual lifetime of the sample during the sample event.

### Embodiment 28

The non-transitory, computer-readable medium of any of Embodiments 23 through 27, wherein the second detector is configured to receive a second plurality of emission signals from the sample during the sample event, and wherein a count of the second plurality of emissions is less than a count of the plurality of emissions.

### Embodiment 29

The non-transitory, computer-readable medium of any of Embodiments 23 through 28, wherein the detector comprises a bright channel, and wherein the second detector comprises a dim channel.

### Embodiment 30

The non-transitory, computer-readable medium of any of Embodiments 23 through 29, wherein determining the pileup factor comprises: determining a deviation between the estimated lifetime and the actual lifetime; and calculating the pileup factor based on the deviation.

### Embodiment 31

The non-transitory, computer-readable medium of any of Embodiments 23 through 30, wherein the adjusting is according to:

$$TPC = MPC / ( 1 - PLF ) ;$$

wherein TPC comprises a number of true number of emissions emitted by the sample; MPC comprises the plurality of emissions signals received by the detector during the sample event time, and PLF comprises the pileup factor.

### Embodiment 32

The non-transitory, computer-readable medium of any of Embodiments 23 through 31, wherein the sample examination system comprises a flow cytometry system.

### Embodiment 33

The non-transitory, computer-readable medium of any of Embodiments 23 through 32, wherein the computer-executable instructions that, when executed, further cause: classifying the sample based at least in part on the pileup factor.

What is claimed:

1. A method, comprising:
collecting, from a sample during a sample event, an emission spectrum that comprises a plurality of emission signals;
based on reception times associated with emission signals of the plurality of emission signals, determining a lifetime estimation for the sample;
determining, based at least on the lifetime estimation, a pileup factor affecting receiving emissions from the sample; and
based on the determined pileup factor, adjusting a number of emission signals measured during the sample event to generate an estimated number of emissions for the sample event.

2. The method of claim 1, wherein determining the lifetime estimation for the sample comprises fitting the reception times for the emissions signals to a model function.

3. The method of claim 2, wherein the model function comprises a regression function.

4. The method of claim 3, wherein the regression function comprises a least squares function.

5. The method of claim 1, wherein the pileup factor is determined as a function of the lifetime estimation and an actual lifetime of the sample.

6. The method of claim 5, wherein determining the actual lifetime comprises retrieving the actual lifetime from electronic storage.

7. The method of claim 5, wherein determining the actual lifetime comprises measuring the actual lifetime prior to determining the lifetime estimation.

8. The method of claim 1, wherein the emission spectrum is a first emission spectrum and is collected by a first detector region, wherein the lifetime estimation is a first lifetime estimation, wherein the pileup factor is a first pileup factor associated with the first detector region, and wherein the method further comprises adjusting, based on the first pileup factor, a number of emission signals measured during the sample event by the first detector region.

9. The method of claim 8, further comprising:
collecting a second emission spectrum from the sample during the sample event with a second detector region;
based on reception times associated with emission signals, determining a second lifetime estimation for the sample;
determining, based at least on the second lifetime estimation, a second pileup factor affecting receiving emissions from the sample; and
based on the determined second pileup factor, adjusting a number of emission signals measured during the sample event by the second detector region.

10. The method of claim 1, further comprising dividing the plurality of emission signals into a first channel and a second channel, wherein a count of the first channel differs from a corresponding count of the second channel.

11. The method of claim 10, wherein the first channel has a count greater than a corresponding count of the second channel.

12. The method of claim 5, wherein determining the pileup factor comprises:
determining a deviation between the lifetime estimation and the actual lifetime; and
calculating the pileup factor based on the deviation.

13. The method of claim 1, wherein the adjusting is according to:
$$TPC = MPC / ( 1 - PLF ) ;$$
wherein TPC comprises the estimated number of emissions for the sample event, MPC comprises the number of emissions signals measured during the sample event, and PLF comprises the pileup factor.

14. The method of claim 1, further comprising classifying the sample based on the estimated number of emission signals for the sample event.

15. An apparatus, comprising:
a computing device comprising:
at least one processor; and
memory configured to store computer-executable instructions that, when executed by the at least one processor, cause the apparatus to:
collect, from a sample during a sample event, an emission spectrum that comprises a plurality of emission signals;
based on reception times associated with emission signals of the plurality of emission signals, determine a lifetime estimation for the sample;
determine, based at least on the lifetime estimation, a pileup factor affecting receiving emissions from the sample; and
based on the determined pileup factor, adjust a number of emission signals measured during the sample event to generate an estimated number of emissions for the sample event.

16. The apparatus of claim 15, wherein determining the lifetime estimation for the sample comprises fitting the reception times for the emissions signals to a model function.

17. The apparatus of claim 16, wherein the model function comprises a regression function.

18. The apparatus of claim 17, wherein the regression function comprises a least squares function.

19. The apparatus of claim 15, wherein the pileup factor is determined as a function of the lifetime estimation and an actual lifetime of the sample.

20. The apparatus of claim 19, wherein determining the actual lifetime comprises retrieving the actual lifetime from electronic storage.

21. The apparatus of claim 19, wherein determining the actual lifetime comprises measuring the actual lifetime prior to determining the lifetime estimation.

22. The apparatus of claim 15, wherein the emission spectrum is a first emission spectrum and is collected by a first detector region, wherein the lifetime estimation is a first lifetime estimation, wherein the pileup factor is a first pileup factor associated with the first detector region, and wherein the method further comprises adjusting, based on the first pileup factor, a number of emission signals measured during the sample event by the first detector region.

23. The apparatus of claim 22, wherein the computer-executable instructions, when executed by the at least one processor, further cause the apparatus to:
collect a second emission spectrum from the sample during the sample event with a second detector region;
based on reception times associated with emission signals, determine a second lifetime estimation for the sample;
determine, based at least on the second lifetime estimation, a second pileup factor affecting receiving emissions from the sample; and
based on the determined second pileup factor, adjust a number of emission signals measured during the sample event by the second detector region.

24. The apparatus of claim 15, wherein the computer-executable instructions, when executed by the at least one processor, further cause the apparatus to divide the plurality of emission signals into a first channel and a second channel, wherein a count of the first channel differs from a corresponding count of the second channel.

25. The apparatus of claim 24, wherein the first channel has a count greater than a corresponding count of the second channel.

26. The apparatus of claim 15, wherein determining the pileup factor comprises:
determining a deviation between the lifetime estimation and the actual lifetime; and
calculating the pileup factor based on the deviation.

27. The apparatus of claim 15, wherein the adjusting is according to:
$$TPC = MPC / ( 1 - PLF ) ;$$
wherein TPC comprises the estimated number of emissions for the sample event, MPC comprises the number of emissions signals measured during the sample event, and PLF comprises the pileup factor.

28. The apparatus of claim 15, further comprising classifying the sample based on the estimated number of emission signals for the sample event.
